(19) United States
(12) Patent Application Publication
(10) Pub. No.: US 2010/0330825 A1
(43) Pub. Date: Dec. 30, 2010

(54) CONDUCTIVE CONTACT AND ELECTRONIC APPARATUS EMPLOYING THE SAME

(75) Inventor: CHIEN-MING FAN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/569,860

(22) Filed: Sep. 29, 2009

(30) Foreign Application Priority Data
Jun. 25, 2009 (TW) 98211400

(51) Int. Cl. H01R 12/00; H01R 4/48

(52) U.S. Cl. 439/82; 439/816

(57) ABSTRACT

A conductive contact includes a contacting member and a resilient member. The contacting member includes a contacting component, a fastening component, and a rim. The fastening component includes a fastening neck, a guiding portion, and a blocking portion connected between the fastening neck and the guiding portion. A maximum width of the guiding portion is gradually decreased from a fixing end connected with the blocking portion to a free end opposite to the fixing end, and a thickness of the guiding portion is larger than that of the blocking portion. The rim is connected between the contacting component and the fastening neck. A maximum width of the fastening neck is less than that of the rim and the blocking portion. The resilient member slides through the guiding portion and the blocking portion to fixedly sleeve on the fastening neck.

### BACKGROUND

1. Technical Field

The present disclosure relates to conductive contacts, and particularly to a conductive contact employed in an electronic apparatus.

2. Description of Related Art

Conductive contacts are generally applied in electronic apparatuses such as mobile phones, portable computers, and personal digital assistants (PDAs) for establishing electrical connections between two elements thereof.

A typical conductive contact includes a post and a coiled spring for resiliently supporting the conductive contact. One end of the post inserts into the coiled spring and electrically connects to the coiled spring. However, the post is often constructed in a cylindrical shape, the conductive contact and the coiled spring are smaller, thus it is difficult to assemble and fasten the end of the post into the coiled spring.

Therefore, an improved conductive contact and an electronic apparatus employing the conductive contact are desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a conductive contact in accordance with an exemplary embodiment.

FIG. 2 is a partial isometric view of an electronic apparatus employing the conductive contact in FIG. 1.

FIG. 3 is a cross-sectional view of the electronic apparatus of FIG. 2 taken along the line - thereof.

FIG. 4 is a schematic view of the electronic apparatus of FIG. 2 used as a docking station.

### DETAILED DESCRIPTION

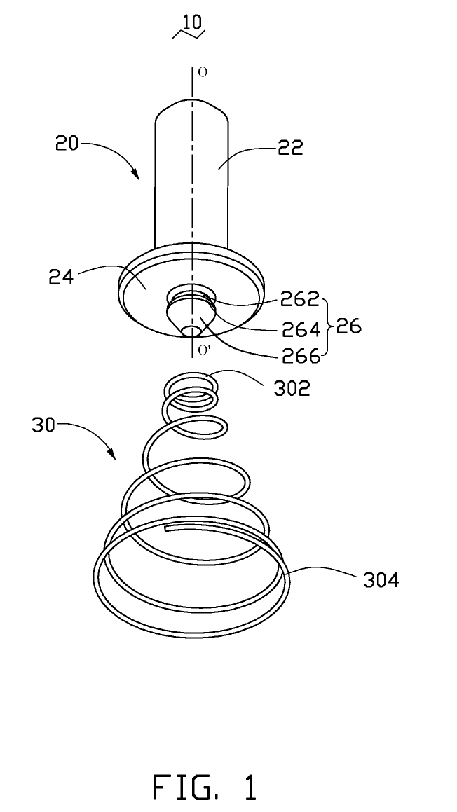

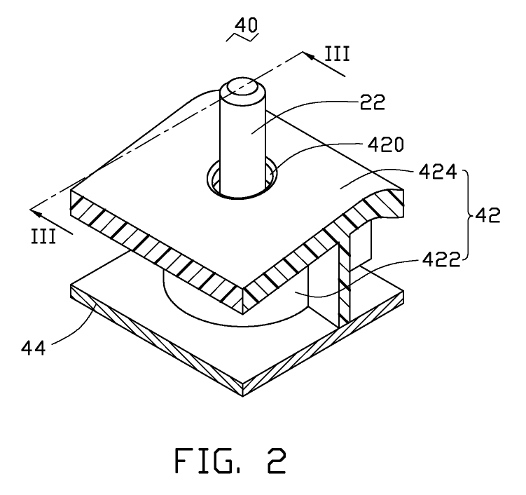

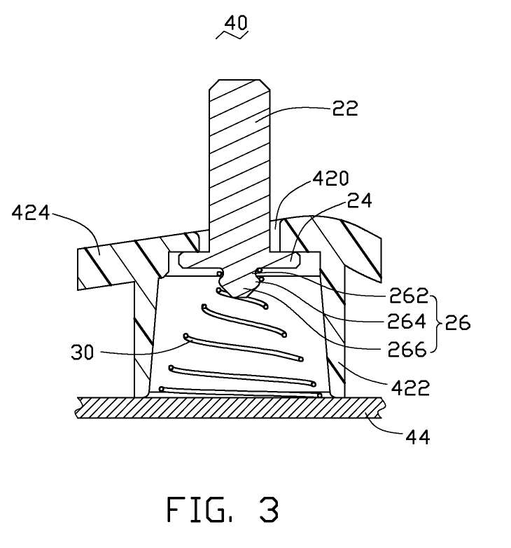

Referring to FIGS. 1-3, an electronic apparatus 40 includes a housing 42, a conductive contact 10, and a conductor 44. The conductive contact 10 is partially received in the housing 42. The electronic apparatus 40 may be a portable computer, a docking station, a foldable disc player, etc.

The conductive contact 10 includes a contacting member 20 and a resilient member 30 connected to the contacting member 20. The contacting member 20 is used for electrically connecting with a conductive pad of another electronic apparatus.

The contacting member 20 is symmetrical around an axis O-O′. The contacting member 20 includes a cylindrical contacting component 22, a disc-shaped rim 24, and a fastening component 26. The rim 24 is connected between the contacting component 22 and the fastening component 26. The contacting component 22 is used for electrically connecting with the conductive pad of another electronic apparatus. The contacting component 22 may be an elongated conductive post. A diameter of the rim 24 is substantially larger than that of the contacting component 22.

The fastening component 26 includes a fastening neck 262, a blocking portion 264, and a guiding portion 266. The blocking portion 264 is connected between the fastening neck 262 and the guiding portion 266. The block portion 264 is disc-shaped. The fastening neck 262 is connected between the rim 24 and the blocking portion 264. A maximum width of cross sections of the fastening neck 262, formed by planes at right angles to the axis O-O′ cutting through the fastening neck 262, is substantially smaller than that of the rim 24 and the blocking portion 264.

A maximum width of cross sections of the guiding portion 266, formed by planes at right angles to the axis O-O′ cutting through the guiding portion 266, are gradually decreased from a fixing end of the guiding portion 266 connecting with the blocking portion 264 to a free end of the guiding portion 266 opposite to the fixing end. A maximum width of cross sections of the fixing end of the guiding portion 266, formed by planes at right angles to the axis O-O′ cutting through the fixing end of the guiding portion 266, is substantially less than that of the blocking portion 264, and a thickness thereof is substantially larger than that of the blocking portion 264. In this embodiment, the guiding portion 266 is substantially truncated cone shaped. In other embodiments, the guiding portion 266 may be substantially conical shaped.

The resilient member 30 is a coiled spring constructed in a conical shape. The resilient member 30 includes a first end 302 and a second end 304 opposite to the first end 302. A maximum width of the first end 302 is substantially less than that of the blocking portion 264 and larger than that of the fastening neck 262.

The housing 42 includes a plate 424 and a tubular receiving portion 422 extending from the plate 424. The plate 424 defines a guiding hole 420 communicating with the receiving portion 422. A maximum width of the guiding hole 420 is substantially less than that of the rim 24 and larger than that of the contacting component 22.

In assembly, the first end 302 of the resilient member 30 sequentially slides through the guiding portion 266 and the blocking portion 264 to fixedly sleeve on the fastening neck 262. Because the maximum width of the fixing end of the guiding portion 266 is substantially less than that of the blocking portion 264, and a thickness of the guiding portion 266 is substantially larger than that of the blocking portion 264, when the first end 302 slides from the guiding portion 266 to the fastening neck 262, the first end 302 is restrictedly unable to slide out of the guiding portion 266. Therefore, the contact member 20 is easily assembled into the first end 302 of the resilient member 300.

In addition, the maximum width of the first end 302 is substantially less than that of the blocking portion 264, as a result the resilient member 30 is steadily fastened on the fastening neck 262.

When the conductive contact 10 is used in the electronic apparatus 40, firstly, the contacting component 22 extends through the receiving portion 422 and the guide hole 420 of the plate 424 to partially protrude out of the plate 424. At the same time, the rim 24 and the fastening component 26 and the resilient member 30 are received in the receiving portion 422.

Then, the conductor 44 is electrically connected with the second end 304 of the resilient member 30, such that the contacting member 20 electrically connects with the conductor 44. Because the maximum width of the rim 24 is substantially larger than that of the guiding hole 420, the rim 24 is restricted by portions of the plate 424 surrounding the guiding hole 420. The resilient member 30 is compressed and deforms, such that pressures correspondingly generated between the rim 24 and the housing 42, and the resilient member 30 and the conductor 44. Therefore, movements between the rim 24 and the housing 42, and the resilient member 30 and the conductor 44 are restricted.

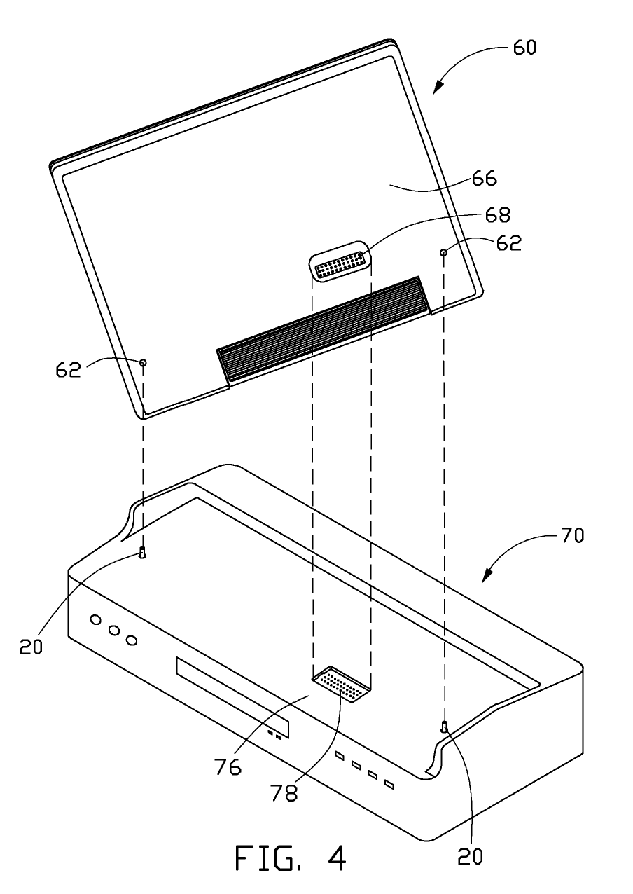

Referring to FIG. 4, the electronic apparatus 40 is used as a docking station 70 for a notebook computer 60. The docking station 70 includes an upper panel 76, an electronic connector 78, and a pair of previously described conductive members 20. The pair of conductive members 20 electrically connects to ground and protrudes out of the upper panel 76. The notebook computer 60 includes a bottom panel 66, a complementary connector 68 fixed on the bottom panel 66, and a pair of conductive pads 62. The complementary connector 68 and the pair of conductive pads 62 are mounted on a circuit board (not shown) and exposed out of the bottom panel 66.

When the notebook computer 60 is mounted onto the docking station 70, the complementary connector 68 aligns with the electronic connector 78. At the same time, the conductive pads 62 align with the corresponding conductive members 20. Once the conductive pads 62 are in contact with the corresponding contacting portions 22 of the conductive members 20, a force is applied to press the conductive members 20 downward. The resilient members 30 are further compressed to deform. The conductive pads 62 electrically connect to ground via the conductive members 20 correspondingly, thus an electro magnetic interference (EMI) generated between the docking station 70 and the notebook computer 60 may be suppressed.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

1. A conductive contact, comprising:
a contacting member comprising:
a contacting component;
a fastening component comprising a fastening neck, a guiding portion, and a blocking portion connected between the fastening neck and the guiding portion, a maximum width of the guiding portion being gradually decreased from a fixing end connected with the blocking portion to a free end opposite to the fixing end, and a thickness of the guiding portion being larger than that of the blocking portion; and
a rim connected between the contacting component and the fastening neck, and a maximum width of the fastening neck being less than that of the rim and the blocking portion; and
a resilient member configured to slide through the guiding portion and the blocking portion to fixedly sleeve on the fastening neck, and the guiding portion adapted to guide the resilient member and prevent the resilient member from sliding out of the contacting member when the resilient member is assembled with the contacting member.

2. The conductive contact according to claim 1, wherein the resilient member is a coiled spring constructed in a conical shape.

3. The conductive contact according to claim 1, wherein the guiding portion is constructed in the shape of a truncated cone.

4. The conductive contact according to claim 1, wherein the resilient member comprising a first end and a second end opposite to the first end, a maximum width of the first end is less than that of the blocking portion and larger than that of the fastening neck, the first end slides through the guiding portion and the blocking portion to fixedly sleeve on the fastening neck.

5. The conductive contact according to claim 1, wherein the rim is disc-shaped.

6. An electronic apparatus, comprising:
a housing comprising a plate and a receiving portion extending from the plate, the plate defining a guiding hole communicating with the receiving portion;
a conductor;
a conductive contact partially received in the receiving portion, the conductive contact comprising:
a contacting member, the contacting member comprising:
a contacting component configured to electrically connect with a conductive pad of another electronic apparatus;
a fastening component comprising a fastening neck, a guiding portion, and a blocking portion connected between the fastening neck and the guiding portion, a maximum width of the guiding portion being gradually decreased from a fixing end connected with the blocking portion to a free end opposite to the fixing end, and a thickness of the guiding portion being larger than that of the blocking portion; and
a rim connected between the contacting component and the fastening neck, and a maximum width of the fastening neck being less than that of the rim and the blocking portion; and
a resilient member electrically connected between the contacting member and the conductor, the resilient member being configured to slide through the guiding portion and the blocking portion to fixedly sleeve on the fastening neck, and the guiding portion adapted to guide the resilient member and prevent the resilient member from sliding out of the contacting member when the resilient member is assembled with the contacting member;
wherein the contacting component passes through the receiving portion and the guiding hole to partially protrude out of the housing;
wherein the rim, the fastening component, and the resilient member are received in the receiving portion.

7. The electronic apparatus according to claim 6, wherein a maximum width of the guiding hole is larger than that of the contacting component and less than that of the rim.

8. The electronic apparatus according to claim 6, wherein the resilient member is a coiled spring constructed in a conical shape.

9. The electronic apparatus according to claim 6, wherein the guiding portion is constructed in the shape of a truncated cone.

10. The electronic apparatus according to claim 9, wherein the receiving portion is tubular.

11. The electronic apparatus according to claim 6, wherein the resilient member comprising a first end and a second end opposite to the first end, a maximum width of the first end is less than that of the blocking portion and larger than that of the fastening neck, the first end slides through the guiding portion and the blocking portion to fixedly sleeve on the fastening neck.

12. The electronic apparatus according to claim 6, wherein the rim is disc-shaped.
